(19) United States
(12) Patent Application Publication
(10) Pub. No.: US 2014/0376327 A1
(43) Pub. Date: Dec. 25, 2014

(54) DEVICE FOR CARRYING OUT MECHANICAL, CHEMICAL, AND/OR THERMAL PROCESSES

(71) Applicant: LIST HOLDING AG, Arisdorf (CH)

(72) Inventors: Pierre-Alain Fleury, Ramlinsburg (CH); Roland Kunkel, Frankfurt a.M. (DE)

(21) Appl. No.: 14/368,626

(22) PCT Filed: Dec. 27, 2012
(86) PCT No.: PCT/EP2012/076928

§ 371 Date: Jun. 25, 2014

(30) Foreign Application Priority Data
Jan. 5, 2012 (DE) 10 2012 100 085.9
Jul. 18, 2012 (DE) 10 2012 106 488.1
Jul. 27, 2012 (DE) 10 2012 106 872.0

(51) Int. Cl. B29B 7/80; B29B 7/48; B29B 7/20

(52) U.S. Cl. CPC B29B 7/802; B29B 7/20; B29B 7/481
USPC 366/97

(57) ABSTRACT

A device for carrying out mechanical, chemical, and/or thermal processes in a housing (3), comprising mixing and cleaning elements (5) on at least two shafts (1, 2), the mixing and cleaning elements (5) on the shafts (1, 2) meshing with each other and being equipped with disk elements that include kneading bars. The number of disk elements including kneading bars is adjusted to the speed ratio between the shafts.

### BACKGROUND OF THE INVENTION

The present invention relates to a device for carrying out mechanical, chemical and/or thermal processes in a housing comprising mixing and cleaning elements on at least two shafts, wherein the mixing and cleaning elements of the shafts engage in one another and have disk elements with kneading bars.

Such devices are also referred to as mixing kneaders. They serve for a wide variety of different purposes. To be mentioned first is evaporation with solvent recovery, which is performed batchwise or continuously and often also under a vacuum. By way of example, this is used for treating distillation residues and, in particular, toluene diisocyanates, but also production residues with toxic or high-boiling solvents from the chemical industry and pharmaceutical production, wash solutions and paint sludges, polymer solutions, elastomer solutions from solvent polymerization, adhesives and sealing compounds.

The apparatuses are also used for carrying out continuous or batchwise contact drying of water-moist and/or solvent-moist products, often likewise under a vacuum. Intended applications are in particular for pigments, dyes, fine chemicals, additives, such as salts, oxides, hydroxides, antioxidants, temperature-sensitive pharmaceutical and vitamin products, active substances, polymers, synthetic rubbers, polymer suspensions, latex, hydrogels, waxes, pesticides and residues from chemical or pharmaceutical production, such as salts, catalysts, slags, waste liquors. These processes also find applications in food production, for example in the production and/or treatment of block milk, sugar substitutes, starch derivatives, alginates, for the treatment of industrial sludges, oil sludges, bio sludges, paper sludges, paint sludges and generally for the treatment of tacky, crust-forming viscous-pasty products, waste products and cellulose derivatives.

In a mixing kneader, a polycondensation reaction can take place, usually continuously and usually in the melt, and is used in particular in the treatment of polyamides, polyesters, polyacetates, polyimides, thermoplastics, elastomers, silicones, urea resins, phenolic resins, detergents and fertilizers. For example, it is applied to polymer melts after mass polymerization of derivatives of methacrylic acid.

A polymerization reaction can also take place, likewise usually continuously. This is applied to polyacrylates, hydrogels, polyols, thermoplastic polymers, elastomers, syndiotactic polystyrene and polyacrylamides.

In mixing kneaders, degassing and/or devolatilization can take place. This is applied to polymer melts, after (co)polymerization of monomer(s), after the condensation of polyester or polyamide melts, to spinning solutions for synthetic fibers and to polymer or elastomer granules or powders in the solid state.

Quite generally, solid, liquid or multi-phase reactions can take place in the mixing kneader. This applies in particular to back-reactions, in the treatment of hydrofluoric acid, stearates, cyanides, polyphosphates, cyanuric acids, cellulose derivatives, cellulose esters, cellulose ethers, polyacetal resins, sulfanilic acids, Cu-phthalocyanines, starch derivatives, ammonium polyphosphates, sulfonates, pesticides and fertilizers.

Furthermore, solid/gas reactions can take place (for example carboxylation) or liquid/gas reactions can take place. This is applied in the treatment of acetates, acids, Kolbe-Schmitt reactions, for example BON, Na salicylates, parahydroxybenzoates and pharmaceutical products.

Liquid/liquid reactions take place in the case of neutralization reactions and transesterification reactions.

Dissolution and/or degassing takes place in such mixing kneaders in the case of spinning solutions for synthetic fibers, polyamides, polyesters and celluloses.

What is known as flushing takes place in the treatment or production of pigments.

A solid-state post-condensation takes place in the production or treatment of polyesters, polycarbonates and polyamides, a continuous slurrying, for example in the treatment of fibers, for example cellulose fibers, with solvents, crystallization from the melt or from solutions in the treatment of salts, fine chemicals, polyols, alkoxides, compounding, mixing (continuously and/or batchwise) in the case of polymer mixtures, silicone compounds, sealing compounds, fly ash, coagulation (in particular continuously) in the treatment of polymer suspensions.

In a mixing kneader, multi-functional processes can also be combined, for example heating, drying, melting, crystallizing, mixing, degassing, reacting—all of these continuously or batchwise. Substances which are produced or treated by these means are polymers, elastomers, inorganic products, residues, pharmaceutical products, food products, printing inks.

In mixing kneaders, vacuum sublimation/desublimation can also take place, whereby chemical precursors, for example anthraquinone, metal chlorides, ferrocene, iodine, organometallic compounds etc., are purified. Furthermore, pharmaceutical intermediates can be produced.

A continuous carrier-gas desublimation takes place, for example, in the case of organic intermediates, for example anthraquinone and fine chemicals.

A distinction is substantially made between single-shaft and dual-shaft mixing kneaders. A multi-shaft mixing and kneading machine is described in CH-A 506 322. In this machine, radial disk elements and axially oriented kneading bars arranged between the disks are located on a shaft. Mixing and kneading elements shaped in a frame-like manner engage between said disks from the other shaft. These mixing and kneading elements clean the disks and kneading bars of the first shaft. The kneading bars on both shafts in turn clean the inner wall of the housing.

These known dual-shaft mixing kneaders have the disadvantage that, owing to the eight-shaped housing cross section, they have a weak point in the region in which the two shaft housings are connected. In this region, high stresses are produced during the processing of tough products and/or during processes which proceed under pressure, and these stresses can only be controlled by complex design measures.

A mixing kneader of the type mentioned above is known from EP 0 517 068 B1, for example. In it, two shafts extending axially parallel rotate in a counter-rotating or co-rotating manner in a mixer housing. In this case, mixing bars mounted on disk elements act with one another. Apart from the function of mixing, the mixing bars have the task of cleaning as well as possible surfaces of the mixer housing, of the shafts and of the disk elements that are in contact with the product and of thereby avoiding unmixed zones. Particularly in the case of highly compacting, hardening and crust-forming products, the ability of the mixing bars to reach the edges leads to high local mechanical loading of the mixing bars and of the shafts. These force peaks occur in particular when the mixing bars engage in those zones where the product finds it difficult to escape. Such zones are present, for example, where the disk elements are mounted on the shaft.

Furthermore, DE 199 40 521 A1 discloses a mixing kneader of the type mentioned above, in which the carrying elements form a recess in the region of the kneading bars in order that the kneading bar has the greatest possible axial extent. Such a mixing kneader has outstanding self-cleaning of all the surfaces of the housing and of the shafts that come into contact with the product, but has the characteristic that the carrying elements of the kneading bars require recesses on account of the paths of the kneading bars, leading to complicated forms of the carrying elements. One result of this is a complex production process and another result is local stress peaks at the shaft and the carrying elements under mechanical loading. These stress peaks, which occur primarily at the sharp-edged recesses and changes in thickness, in particular in the region where the carrying elements are welded onto the core of the shaft, are causes of cracks in the shaft and the carrying elements as a result of material fatigue.

The present device is intended to relate especially to a mixing kneader for producing a super-absorbing polymer (SAP). Up till now, use has been made for this purpose only of twin-shaft mixing kneaders rotating in an opposed manner with a rotational ratio of 4:1. These kinematics result in undesirable effects, namely inadequate self-cleaning properties, bypassing of product and torque peaks, in particular if, for example, SAP powder is intended to be recycled.

Although, in the case of mixing kneaders of this type, the self-cleaning of the housing is at around 100%, the cleaning of the shafts is insufficient in order to avoid polymer deposits. Dead zones which can expose the polymer to higher temperatures are formed, and therefore, on the basis of exothermal reactions, hot spots form within said regions. This particularly hot polymer is discolored to a yellowish to brown color, falls off after some days and contaminates the good product. This discolored polymer also breaks into large pieces on dropping downward. Said pieces are so rubbery that they remain in this size, even when they are squeezed through between the kneading elements. One possibility of breaking said pieces into smaller pieces is to run the mixing kneader with a high filling level in order to push these pieces through the narrowest gaps. Although this helps, it does not solve the problem. Two consequences can be determined:
a downstream drying stage for completely drying these large pieces is overtaxed, or else an apparatus has to be installed between mixing kneader and dryer in order to cut the pieces into small pieces, wherein an apparatus of this type requires intensive maintenance.
the mixing kneader becomes overloaded as a consequence of the excessively high filling level and the resulting friction in the product.

The contra-rotating shafts furthermore produce local forces when a solid powder is fed into the polymer compound, for example using twin feed screws. Solid powder is, for example, recycled SAP and optionally a filler. If the two shafts interact with the polymer in the form of solid powder, the local pressure becomes so high that, just after a few months of activity, fractures can occur at the kneading elements. The shafts themselves can likewise be overloaded. Solid powder is also used in a large quantity in order to solve the problem of clumps. The coefficient of friction of the solid powder assists in feeding kneading energy into the large polymer pieces. However, even this does not eliminate the clumps, but rather increases the torque.

The mixing kneader 4:1 is driven with a high filling level in order also to avoid polymer pieces being bypassed. The quicker shaft has the tendency to convey the pieces floating at the top rapidly toward the discharge. A high filling level toward 1 decelerates said polymer pieces such that they remain for a longer time in the kneader in order to be comminuted.

It is an object of the present invention to significantly improve a device of the type mentioned above, which will be referred to below as a mixing kneader, specifically in terms of the treatment of the product, in terms of the cleaning of the surfaces coming into contact with the product and in terms of the torque peaks during the metering in of powder, and also in terms of the discharge of the product. The device here is intended to relate especially to the production of SAP. The invention permits a normal filling level, in order to empty the machine.

### SUMMARY OF THE INVENTION

The object is achieved in that the number of disk elements with kneading bars is matched to the ratio of the rotational speed of the shafts with respect to one another.

The self-cleaning is considerably improved by this mixing kneader according to the invention. Whereas, in the case of the opposed reactors used hitherto, dead zones which could increase to more than 60% of the free space in the direction of the inner wall of the housing arose between the disk elements, this does not take place in more than 18-20% of the space depth in the reactor according to the invention. The volume of the dead zones is at least two times smaller than in standard reactors. However, the main advantage of the remaining dead zones consists in that the latter are not sufficiently wide in the space or sufficiently concentrated at one point. This avoids hot spots in the dead zones. The good product is also not contaminated by this means, and therefore the required standards are achieved.

The recycling of SAP residues also takes place more easily in the novel reactor. In practice, it could be demonstrated that the local pressure on the kneading elements is two times lower than in the case of the contra-rotating shafts. This advantage permits the addition of filler combined with solid SAP powder at the same point of the reactor. Use is customarily made here of a twin screw flushed with nitrogen in order to add the additional material to the mixing kneader. The addition usually takes place in the second half of the reactor when the monomer conversion is already relatively high.

It has been found, for the ratio of the rotational speeds of the two shafts with respect to each other, that the ratio of 1:1 or of 4:5 or 2:3 is most suitable. In the case of the ratio of 2:3, for example, six revolutions are necessary before the mixing elements meet again. The added material is thereby better mixed in the polymer. Furthermore, the rotational speed of the quicker shaft is intended to be at max. 1.5 times quicker than that of the other shaft in order to avoid any rapid movement (acceleration) which could create bypasses of the product.

According to the invention, the disk elements are configured with a plurality of points. According to the invention, each disk element here has as many points as the ratio of the rotational speed with respect to one another. If the rotational speed is therefore 2:3, one disk element has two points, and the second disk element has three points. The disk elements are themselves also designed in a corresponding manner, since the points are in each case connected to one another in a corresponding manner. The disk element with two points is related to an ellipse, and the disk element with three points to a three-point star. The disk element with four points approximately corresponds to a square, etc.

The respective disk elements are preferably also provided on the shafts in twin form, wherein they are directly consecutive or maintain only a slight distance from one another on the shaft. According to the invention, they are also arranged rotated in relation to one another, wherein the rotation corresponds in each case to 360° divided by the respective number of points.

At least one of the shafts is intended to have a double mounting on at least one side in order to remove the shafts of load. Above all, the natural vibration of the shaft is damped by the double mounting of the shaft. It may prove advisable here to provide a sleeve between the shaft and the corresponding two bearings. The accommodating of the shaft in the bearing region is thereby simplified. If the shaft has to be repaired, it can more easily be exchanged.

Furthermore, at least one of the shafts is intended to be produced from a forged and turned/milled tube segment in order to remove the weld seams from the shaft core.

The housing is preferably intended to have an L/D ratio of at max. 5.3 in order to remove the shafts of load.

Furthermore, the novel configuration of the reactor improves the micromixing in the addition region of the reactor. This applies, for example, in the case of ascorbic acid, which has to be well mixed with the monomer, being added.

According to the invention, the mixing and cleaning elements are intended to each consist of a disk element, and the disk element is intended to have an outer marginal edge, which extends by a radius in an arc segment of approximately 90° or slightly higher about the axis of the shaft and is adjoined at both ends by side edges extending toward the shaft, wherein one or more bars sits/sit on each marginal edge. The kneading bars preferably have sharp edges so that they can cut the product particles in the engagement zones.

In this configuration, it is no longer possible to distinguish between a cleaning and a stirring shaft, as is still customary in the prior art. The mixing and cleaning elements on both shafts both have mixing and cleaning tasks. They carry out intensive and very extensive cleaning of all of the surfaces and elements that come into contact with the product. This applies to the inner wall of the housing, to mixing and cleaning elements themselves and also to the shell of the shafts.

The mixing and cleaning elements should preferably be formed identically on both shafts. This not only simplifies production and maintenance, but also leads to uniform loading of the individual operating elements, for example of bars as parts of the mixing and cleaning elements.

An essential feature of the present invention also relates to the configuration of the mixing and cleaning elements. These are each composed of a disk element and at least one bar which is attached to said disk element and extends in the axial direction. However, in this case the disk elements are preferably configured such that they delimit only part of the kneading chamber and, since they are arranged offset rotationally symmetrically by 180° in relation to one another on the axis, also only ever delimit the kneading chamber on one side. This has the effect that the product stream is guided radially back and forth as it is conveyed from an entry to a discharge, as in a labyrinth. This provides optimum radial mixing, which was known to date in this form. This avoids the product being bypassed.

Furthermore, the arrangement of the disk elements of the mixing and cleaning elements also provides a continuous gas chamber, which leads to a significantly improved discharge of evaporated solvent/water or the like.

In a particularly preferred exemplary embodiment, the disk elements have an outer marginal edge which extends by a radius about the axis of the shaft. In this respect, the disk element covers an arc segment of about 90° or slightly higher.

Furthermore, a bar is preferably attached to the marginal edge of the disk element at both ends. Cleaning can be improved even by providing a middle bar between the two bars.

Furthermore, it has become apparent in practice that the same geometries of both shafts and of the mixing and cleaning elements thereon result in significantly more uniform flow of the product stream. Furthermore, the arrangement selected provides a high self-cleaning effect, which in turn also leads to a better (closer) residence time distribution and, at the same time, to an intensive mixing and kneading action.

In addition, the mixing and cleaning elements selected also make very good back mixing possible, if the conveying elements, in particular the bars, are operated appropriately. Accordingly the arrangement selected is also ideal for batch machines.

At least one shaft is intended to be actively heatable or coolable. The transmission of heat into the product is therefore improved. It is even conceivable for at least one shaft to be divided into two different heat transmission zones, which enables the added compound to be heated up and, if the heating takes place exothermally, allows, in addition to evaporative cooling, the product to cool down.

The reactor is operated under vacuum, under normal pressure or under positive pressure in order to cool down the reaction heat by evaporating water at a specified temperature.

Furthermore, it is possible for a single-shaft or multi-shaft discharge screw to be assigned to the discharge opening. Said discharge screws can optionally be controlled by weighing cells in order to regulate the filling level of the reactor. They can be arranged horizontally or vertically, on the end wall or on the housing.

A steam vent is preferably intended to be assigned to the discharge screw, in particular in the upper region thereof or on the drive side, in order to remove the steam which arises from the evaporative cooling.

A further concept of the invention relates to the assignment of weighing cells to the device or to the housing, with which weighing cells the content/hold-up of the housing is determined. In a preferred exemplary embodiment of the invention, this content/hold-up can be controlled via the rotational speed of the discharge screw, i.e. if the content of the housing is to be increased, the rotational speed of the discharge screw is decelerated (or accelerated in the reverse case).

On the other hand, it is also possible, of course, to keep a filling level of the device constant by controlling the rotational speed of the discharge screw via the signal of the weighing cells. If the filling level threatens to drop, the rotational speed is decelerated. If the filling level threatens to rise, the rotational speed is increased and the discharge is therefore accelerated.

In a further preferred exemplary embodiment, it is conceived to monitor the torque of the shafts. A deviation of the torque of the shafts indicates a possible error in the method carried out. The composition of the added components (neutralization portion, redox crosslinking and thermal initiators, inertization, contamination, portion of recycled SAP powder, portion of filler) can therefore be monitored on line. The measured torque for a certain filling level is a quality parameter which is measurable during the operation.

### BRIEF DESCRIPTION OF THE DRAWINGS

Further advantages, features and details of the invention will become apparent from the following description of preferred exemplary embodiments and also with reference to the drawing, in which

FIG. 1 shows a front view of a device according to the invention for carrying out mechanical, chemical and/or thermal processes (mixing kneader) with a removed end disk;

FIG. 2 shows a partially illustrated longitudinal section through a mixing kneader similar to FIG. 1;

FIG. 3 shows a schematic illustration of part of a developed view of a mixing kneader according to FIGS. 1 and 2;

FIG. 4 shows a partially illustrated longitudinal section through a device according to the invention according to FIG. 1;

FIG. 5 shows a schematic view of two intermeshing shafts of a mixing kneader according to the invention with a rotational speed ratio of 2:3;

FIG. 6 shows a schematic view of two intermeshing shafts of a mixing kneader according to the invention with a rotational speed ratio of 3:3;

FIG. 7 shows a schematic view of two intermeshing shafts of a mixing kneader according to the invention with a rotational speed ratio of 3:4.

### DETAILED DESCRIPTION

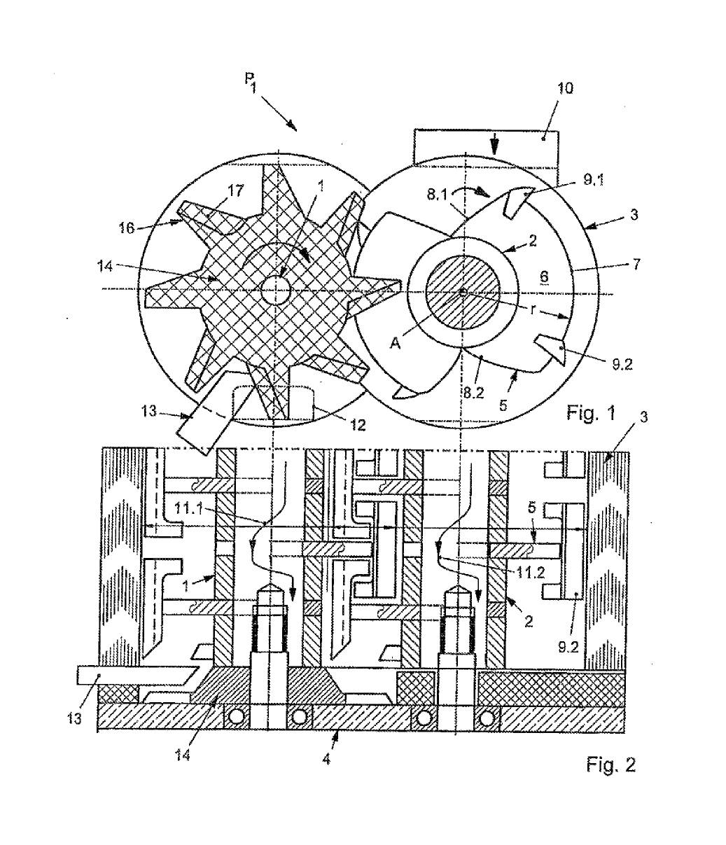

According to FIGS. 1 and 2, there are two shafts 1 and 2 in a housing 3 of a mixing kneader P1, it being possible for both the shafts 1 and 2 and the housing 3 to be filled with a temperature-controlled medium. For this purpose, the housing 3 is then formed as a twin-shell housing. On the front side, the housing 3 is closed by an end plate 4.

Mixing and cleaning elements 5 of a substantially identical form sit on the shafts 1 and 2. They consist of a disk element 6, having a marginal edge 7 which extends approximately in a radius R about an axis A of the shaft 1 or 2 and in an arc segment of about 90°. Side edges 8.1 and 8.2 then extend from the marginal edge 7 in an arcuate manner toward the shaft 1 or 2. Such disk elements are arranged in succession on the shaft 1 or 2 such that they are rotationally symmetrical by 180°.

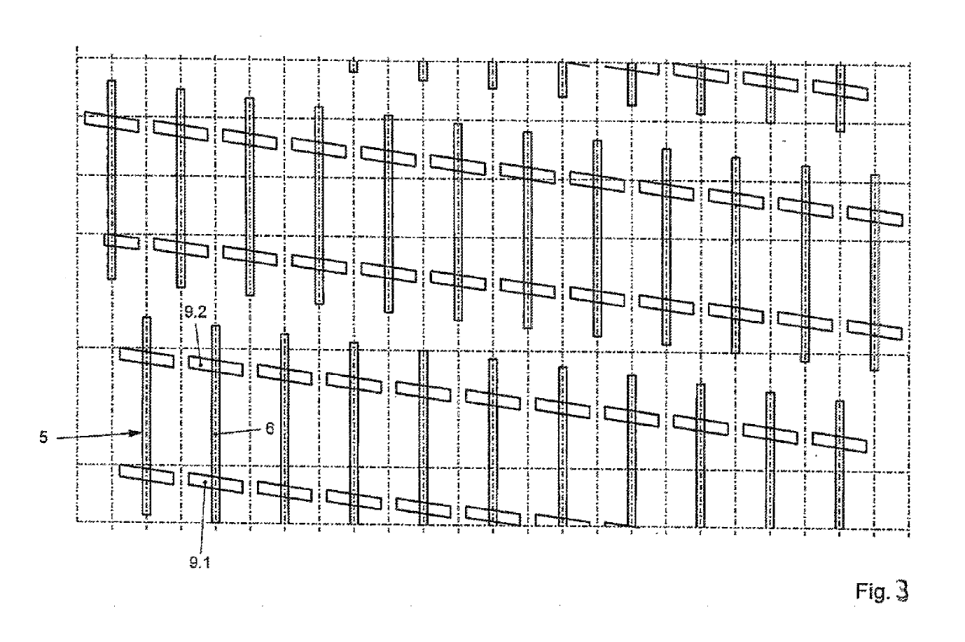

Furthermore, it can be seen that the marginal edge 7 is occupied by two bars 9.1 and 9.2, which extend approximately parallel to the axis A but, in the developed views shown in FIG. 3, are formed obliquely. It is thereby possible to influence the conveying activity of the product to be processed.

The mode of operation of the present invention is as follows:

A product to be treated passes via an entry 10 into the interior of the housing 3, where it is detected by the rotating mixing and cleaning elements 5 on the shafts 1 and 2. In the process, the product is intensively kneaded and sheared by the mixing and cleaning elements 5, such that it can be intensively mixed with other products, additives, solvents, catalysts, initiators, etc. In contrast to known mixing kneaders, in the present invention it is no longer possible to distinguish between a stirring shaft with stirring elements and a cleaning shaft with cleaning elements. According to the present invention, the shafts 1 and 2 with the mixing and cleaning elements thereof take on to an equal extent the mixing of the product and the cleaning of the other shaft or of the inner wall of the housing or of the mixing and cleaning elements on the other shaft.

The described arrangement of the disk element and the configuration thereof implement optimum radial mixing and, in particular, make a “labyrinth effect” possible, as is illustrated by the arrows 11.1 and 11.2 for the product. Here, it is assumed that both shafts rotate in a co-rotating manner in a ratio of 1:1, in the present case in the clockwise direction.

As soon as the product passes in the direction of the end plate 4, i.e. to a discharge 12 (indicated by dashed lines), according to the invention it should be deflected toward said discharge 12. This is done using a deflector 13 in cooperation with a discharge star 14. Whereas the deflector 13 is fixed statically in the housing, the discharge star 14 rotates together with the shaft 1, the discharge star being provided with a plurality of cutting teeth that press the product to be discharged into the discharge opening 12. The cutting teeth have cutting edges 17 in the direction of rotation. As a result, a portion is always cut off from the product stream and pressed through the discharge opening 12.

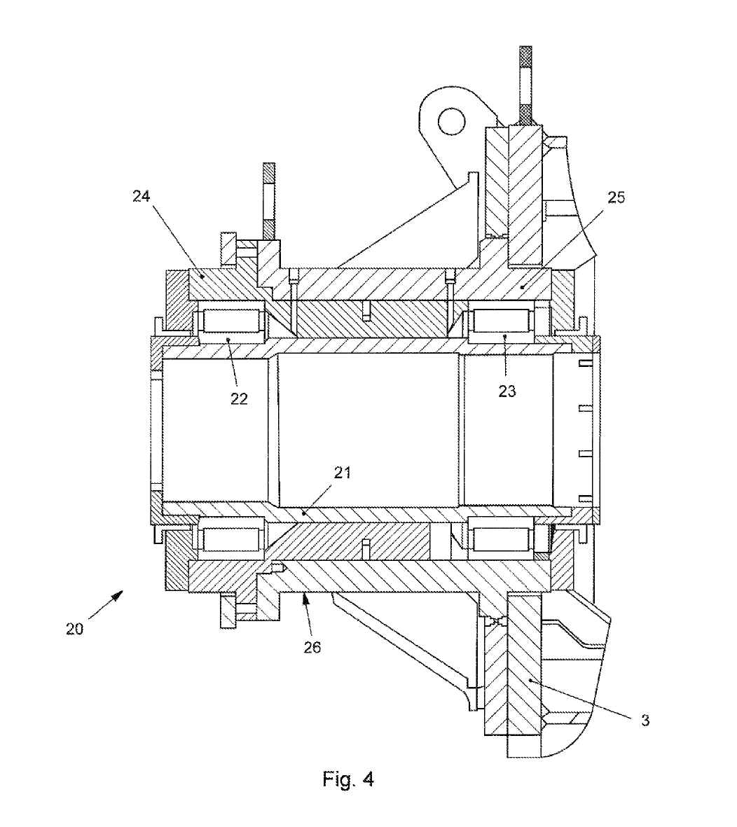

FIG. 4 illustrates a part of the device according to the invention, in particular in the region of a bearing lantern 20. A sleeve 21 which is supported against parts 24 and 25 of a bearing housing 26 via two bearings 22 and 23 provided spaced-apart rotates in said bearing lantern 20. Said bearing housing 26 is flange-mounted onto the housing 3.

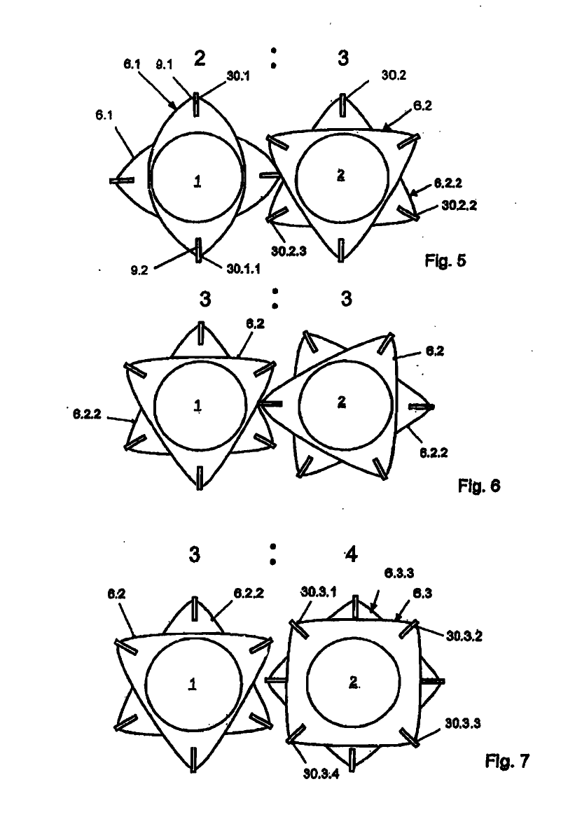

According to FIGS. 5 to 7, the disk elements are configured differently in each case depending on the ratio of the rotational speed of the individual shafts to one another. According to FIG. 5, the shaft 1 rotates in a rotational speed ratio to the shaft 2 of 2:3. According to the present invention, the disk element 6.1 on the shaft 1 is thus formed in an elliptical manner, i.e. it has two opposite points 30.1 and 30.1.1 which are both occupied by a kneading bar 9.1, 9.2.

Preferably directly following the disk element 6.1, there is a further identical disk element 6.1.1 behind the latter, but rotated by 90°.

Further disk elements 6.2 and 6.2.2 on the shaft 2 interact with said disk elements 6.1 and 6.1.1 on the shaft 1. Said shaft 2 rotates with the rotational speed ratio of the ratio 2:3, and therefore the disk elements 6.2 and 6.2.2 are configured with three points 30.2, 30.2.2 and 30.2.3. The points are in each case arranged offset by 120° with respect to one another about the shaft 2. The shaft 6.2.2 is assigned rotated by 60° to the shaft 6.2.

FIG. 6 illustrates the rotational speed ratio 3:3, with correspondingly also only disk elements 6.2 and 6.2.2 being provided.

FIG. 7 illustrates the rotational speed ratio of 3:4. Accordingly, disk elements 6.2 and 6.2.2 are located on the shaft 1 while disk elements 6.3 and 6.3.3 having four points 30.3.1 to 30.3.4 are arranged on the shaft 2. The disk elements 6.3 and 6.3.3 are provided rotated by 45° with respect to each other on the shaft 7.

Any rotational speed ratios to one another are possible in accordance with this pattern.

1-26. (canceled)

27. A device for carrying out mechanical, chemical and/or thermal processes in a housing comprising mixing and cleaning elements on at least two shafts, wherein the mixing and cleaning elements of the shafts engage in one another and have disk elements with kneading bars, the disk elements have a number of points corresponding to a ratio of rotational speed, and a kneading bar is arranged at each point, and the shafts rotate in the same direction.

28. The device as claimed in claim 27, wherein a rotational speed of one shaft is at max. 1.5 times quicker than that of the other shaft.

29. The device as claimed in claim 28, wherein the kneading bars of the mixing and cleaning elements have sharp edges.

30. The device as claimed in claim 28, wherein the kneading bars are arranged in an offset manner on the mixing and cleaning elements.

31. The device as claimed in claim 27, wherein at least one shaft is temperature controlled.

32. The device as claimed in claim 31, wherein at least one shaft is divided axially into two different temperature zones.

33. The device as claimed in claim 27, wherein disk elements are provided on at least one shaft in twin form consecutively without a spacing and rotate with respect to one another.

34. The device as claimed in claim 33, wherein the rotation about a circular measure of 360° takes place divided by the ratio of the speed.
